(19) United States
(12) Patent Application Publication
(10) Pub. No.: US 2007/0158609 A1
(43) Pub. Date: Jul. 12, 2007

(54) Carbon nanoparticle-containing lubricant and grease

(76) Inventors: Haiping Hong, Rapid City, SD (US); Fernand D.S. Marquis, Rapid City, SD (US); John Andrew Waynick, San Antonio, TX (US)

Correspondence Address: GORDON & REES LLP, 101 WEST BROADWAY, SUITE 1600, SAN DIEGO, CA, 92101, US

(21) Appl. No.: 11/332,679

(22) Filed: Jan. 12, 2006

(51) Int. Cl. C09K 5/00

(52) U.S. Cl. 252/71

(57) ABSTRACT

The present invention relates to processes for preparing a stable suspension of carbon nanoparticles in a thermal transfer fluid to enhance thermal conductive properties, viscosity, and lubricity. One process is to disperse carbon nanoparticles directly into a thermal transfer fluid and other additives in the present of surfactants with intermittent ultrasonication. The second process is carried out in three stages. First, carbon nanoparticles are dispersed into a volatile solvent. Then, a thermal transfer fluid, surfactants, and other additives are added into this intermediate dispersion and mixed thoroughly. At last, the volatile solvent is removed to produce a uniformly dispersed nanofluid. The third process is to disperse carbon nanoparticles at an elevated temperature into a homogeneous mixture of surfactants and other additives in a thermal transfer fluid with help of a physical agitation. The present invention also relates to compositions of carbon nanoparticle nanofluids, such as nanolubricants and nanogreases. The nanofluid of the present invention is a dispersion of carbon nanoparticles, particularly carbon nanotubes, in a thermal transfer fluid in the present of surfactants. Addition of surfactants significantly increases the stability of nanoparticle dispersion. For nanogreases, carbon nanoparticles function both as a thickener to modulate viscosity and as a solid heat transfer medium to enhance thermal conductivity and high temperature resistance.

### TECHNICAL FIELD

The present invention relates to processes for producing nanofluids with enhanced thermal conductive properties, viscosity, and lubricity. The present invention also relates to the composition of a nanofluid which is a dispersion of carbon nanoparticles in a thermal transfer fluid in the present of surfactants.

### BACKGROUND OF THE INVENTION

Conventional heat transfer fluids such as water, mineral oil, and ethylene glycol play an important role in many industries including power generation, chemical production, air conditioning, transportation, and microelectronics. However, their inherently low thermal conductivities have hampered the development of energy-efficient heat transfer fluids that are required in a plethora of heat transfer applications. It has been demonstrated recently that the heat transfer properties of these conventional fluids can be significantly enhanced by dispersing nanometer-sized solid particle and fibers (i.e. nanoparticles) in fluids (Eastman, et al., Appl. Phys. Lett. 2001, 78(6), 718; Choi, et al., Appl. Phys. Lett. 2001, 79(14), 2252). This new type of heat transfer suspensions is known as nanofluids. Carbon nanotube-containing nanofluids provide several advantages over the conventional fluids, including thermal conductivities far above those of traditional solid/liquid suspensions, a nonlinear relationship between thermal conductivity and concentration, strongly temperature-dependent thermal conductivity, and a significant increase in critical heat flux. Each of these features is highly desirable for thermal systems and together make nanofluids strong candidates for the next generation of heat transfer fluids.

The observed substantial increases in the thermal conductivities of nanofluids can have broad industrial applications and can also potentially generate numerous economical and environmental benefits. Enhancement in the heat transfer ability could translate into high energy efficiency, better performance, and low operating costs. The need for maintenance and repair can also be minimized by developing a nanofluid with a better wear and load-carrying capacity. Consequently, classical heat dissipating systems widely used today can become smaller and lighter, thus resulting in better fuel efficiency, less emission, and a cleaner environment.

Nanoparticles of various materials have been used to make heat transfer nanofluids, including copper, aluminum, copper oxide, alumina, titania, and carbon nanotubes (Keblinski, et al, Material today, 2005, 36). Of these nanoparticles, carbon nanotubes show greatest promise due to their excellent chemical stability and extraordinary thermal conductivity. Carbon nanotubes are macromolecules of the shape of a long thin cylinder and thus with a high aspect ratio. There are two main types of carbon nanotubes: single-walled nanotubes (“SWNT”) and multi-walled nanotubes (“MWNT”). The structure of a single-walled carbon nanotube can be described as a single graphene sheet rolled into a seamless cylinder whose ends either open or capped by either half fullerenes or more complex structures including pentagons. Multi-walled carbon nanotubes comprise an array of such nanotubes that are concentrically nested like rings of a tree trunk with a typical distance of approximately 0.34 nm between layers.

Carbon nanotubes are the most thermal conductive material known today. Basic research over the past decade has shown that carbon nanotubes could have a thermal conductivity an order of magnitude higher than copper, 3,000 W/m·K for multi-walled carbon nanotubes and 6,000 W/m·K for single-walled carbon nanotubes. Therefore, the thermal conductivities of nanofluids containing such solid particles would be expected to be significantly enhanced when compared with conventional fluids along. Experimental results have demonstrated that carbon nanotubes yield by far the highest thermal conductivity enhancement ever achieved in a fluid: a 150% increase in conductivity of oil at about 1% by volume of multi-walled carbon nanotubes (Choi, et al., App. Phys. Lett., 2001, 79(14), 2252).

Several additional studies of carbon nanotube suspensions in various heat transfer fluids have since been reported. However, only moderate enhancements in thermal conductivity have been observed. Xie et al. measured a carbon nanotube suspension in an aqueous solution of organic liquids and found only 10-20% increases in thermal conductivity at 1% by volume of carbon nanotubes (Xie, et al., J. Appl. Phys., 2003, 94(8):4967). Similarly, Wen and Ding found an about 25% enhancement in the conductivity at about 0.8% by volume of carbon nanotubes in water (Wen and Ding, J. Thermophys. Heat Trans., 2004, 18:481).

Despite those extraordinary promising thermal properties exhibited by carbon nanotube suspensions, it remains to be a serious technical challenge to effectively and efficiently disperse carbon nanotubes into aqueous or organic mediums to produce a nanoparticle suspension with a sustainable stability and consistent thermal properties. Due to hydrophobic natures of graphitic structure, carbon nanotubes are not soluble in any known solvent. They also have a very high tendency to form aggregates and extended structures of linked nanoparticles, thus leading to phase separation, poor dispersion within a matrix, and poor adhesion to the host. However, stability of the nanoparticle suspension is especially essential for practical industrial applications. Otherwise, the thermal properties of a nanofluid, such as thermal conductivity, will constantly changed as the solid nanoparticles gradually separate from the fluid. Unfortunately, these early studies on carbon nanotubes-containing nanofluids have primarily focused on the enhancement of thermal conductivity and very little experimental data is available regarding the stability of those nanoparticle suspensions.

Accordingly, there is a great need for the development of an effective formulation which can be used to efficiently disperse different forms of carbon nanotubes into a desired heat transfer fluid and produce a nanofluid with a sustainable stability and consistent thermal properties. Hence, the present invention relates to a composition of a nanofluid which contains a conventional heat transfer fluid, a surfactant, and carbon nanoparticles. Particularly, the present invention relates to the development of a nanolubricant and nanogrease with enhanced thermal conductivities and increased viscosities. The surfactant is used to facilitate the nanoparticle dispersing process and also to increase the stability of the nanofluid thus produced.

### SUMMARY OF THE INVENTION

The objective of the present invention is to enhance thermal conductive properties, viscosity, and lubricity of conventional thermal transfer fluids using solid carbon nanoparticles such as carbon nanotubes. Another objective of the present invention is to provide a method to stabilize such nanoparticle dispersion.

In accordance with the present invention, three processes for preparing a stable suspension of carbon nanoparticles in a thermal transfer fluid are disclosed. In one embodiment, the nanofluid is produced by dispersing dry carbon nanoparticles directly into a mixture of a thermal transfer fluid and other additives in the present of surfactants with help of a physical agitation such as ultrasonication. If ultrasonication is used, it is preferably to ultrasonicate the carbon nanoparticle-containing mixture intermittently to avoid causing structural damage to the nanoparticles, especially for carbon nanotubes.

In another embodiment, the nanofluid is produced in three stages. At first, dry carbon nanoparticles are evenly dispersed into a volatile solvent, such as an organic solvent like chloroform, with help of a physical agitation to form an intermediate dispersion. Then, a thermal transfer fluid, surfactants, and other additives are added to this intermediate nanoparticle dispersion and mixed thoroughly with help of a physical agitation. Lastly, the volatile solvent is removed to produce a uniformly dispersed nanofluid.

In yet another embodiment, the nanofluid is prepared by dispersing carbon nanoparticles at elevated temperatures. Prior to the addition of carbon nanoparticles, a homogeneous mixture of surfactants and other additives in a thermal transfer fluid is first prepared. Heating and a physical agitation, such as mechanical stirring, can also be applied to help the preparation of the mixture. The dispersion of carbon nanoparticles is then carried out at an elevated temperature range, at which no adversary reactions occur between the chemicals and carbon nanoparticles, and of which the highest temperature is below the boiling point of any chemical in the thermal transfer fluid mixture. During the dispersion process, carbon nanoparticles are added slowly in small portion with help of a physical agitation. After addition, the mixture is blended further to ensure producing a homogeneous dispersion.

The present invention also relates to compositions of nanofluids, including nanolubricants and nanogreases. A nanofluid is a dispersion of carbon nanoparticles in a conventional thermal transfer fluid. More particularly, the nanofluid of the present invention contains one or more surfactant to stabilize the nanoparticle dispersion. Other classical chemical additives can also be added to provide other desired chemical and physical characteristics, such as antiwear, corrosion protection and thermal oxidative properties. For the nanogreases of the present invention, carbon nanoparticles function both as a thickening agent to modulate viscosity and as a solid heat transfer medium to enhance thermal conductivity.

### DETAILED DESCRIPTION OF THE INVENTION

The present invention relates to three processes for preparing a stable suspension of carbon nanoparticles in a thermal transfer fluid to enhance thermal conductive properties, viscosity, and lubricity. One process is to disperse carbon nanoparticles directly into a thermal transfer fluid and other additives in the present of surfactants with intermittent ultrasonication. The second process is carried out in three stages. First, carbon nanoparticles are dispersed into a volatile solvent. Then, a thermal transfer fluid, surfactants, and other additives are added into this intermediate dispersion and mixed thoroughly. At last, the volatile solvent is removed to produce a uniformly dispersed nanofluid. The third process is to disperse carbon nanoparticles at an elevated temperature into a homogeneous mixture of surfactants and other additives in a thermal transfer fluid with help of a physical agitation. The present invention also relates to compositions of carbon nanoparticle nanofluids, such as a nanolubricant and nanogrease. The nanofluid of the present invention is a dispersion of carbon nanoparticles, particularly carbon nanotubes, in a thermal transfer fluid in the present of surfactants. Addition of surfactants significantly increases the stability of nanoparticle dispersion. For nanogreases, carbon nanoparticles serve both as a thickener to modulate viscosity and as a solid heat transfer medium to enhance thermal conductivity and high temperature resistance.

As used in this disclosure, the singular forms “a”, “an”, and “the” may refer to plural articles unless specifically stated otherwise. To facilitate understanding of the invention set forth in the disclosure that follows, a number of terms are defined below.

### Definitions:

The term “carbon nanotube” refers to a class of macromolecules which have a shape of a long thin cylinder.

The term “aspect ratio” refers to a ratio of the length over the diameter of a particle.

The term “SWNT” refers to single-walled carbon nanotube.

The term “MWNT” refers to multi-walled carbon nanotube.

The term “D-SWNT” refers to a double-walled carbon nanotube.

The term “F-SWNT” refers to a fluorinated SWNT.

The term “carbon nanoparticle” refers to a nanoparticle which contain primarily carbon element, including diamond, graphite, fullerenes, carbon nanotubes, and combinations thereof.

The term “PAO” refers to polyalphaolefin.

The term “Polyol ester” refers to an ester of an organic compound containing at least two hydroxyls with at least one carboxylic acid.

The term “surfactant” refers to a molecule having surface activity, including wetting agents, dispersants, emulsifiers, detergents, and foaming agents, etc.

### Carbon Nanoparticles:

Carbon nanoparticles have a high heat transfer coefficient and high thermal conductivity which often exceeds that of the best metallic material. Many forms of carbon nanoparticles can be used in the present invention, including carbon nanotubes, diamond, fullerenes, graphite, and combinations thereof.

Carbon nanotubes (“CNT”) are macromolecules in the shape of a long thin cylinder often with a diameter in few nanometers. The basic structural element in a carbon nanotube is a hexagon which is the same as that found in graphite. Based on the orientation of the tube axis with respect to the hexagonal lattice, a carbon nanotube can have three different configurations: armchair, zigzag, and chiral (also known as spiral). In armchair configuration, the tube axis is perpendicular to two of six carbon-carbon bonds of the hexagonal lattice. In zigzag configuration, the tube axis is parallel to two of six carbon-carbon bonds of the hexagonal lattice. Both these two configurations are achiral. In chiral configuration, the tube axis forms an angle other than 90 or 180 degrees with any of six carbon-carbon bonds of the hexagonal lattice. Nanotubes of these configurations often exhibit different physical and chemical properties. For example, an armchair nanotube is always metallic whereas a zigzag nanotube can be metallic or semiconductive depending on the diameter of the nanotube. All three different nanotubes are expected to be very good thermal conductors along the tube axis, exhibiting a property known as “ballistic conduction,” but good insulators laterally to the tube axis.

In addition to the common hexagonal structure, the cylinder of a carbon nanotube molecule can also contain other size rings, such as pentagon and heptagon. Replacement of some regular hexagons with pentagons and/or heptagons can cause cylinders to bend, twist, or change diameter, and thus lead to some interesting structures such as “Y-”, “T-”, and “X-junctions”. Those various structural variations and configurations can be found in both SWNT and MWNT. However, the present invention is not limited by any particular configuration and structural variation. The carbon nanotube used in the present invention can be in the configuration of armchair, zigzag, chiral, or combinations thereof. The nanotube can also contain structural elements other than hexagon, such as pentagon, heptagon, octagon, or combinations thereof.

Another structural variation for MWNT molecules is the arrangement of the multiple tubes. A perfect MWNT is like a stack of graphene sheets rolled up into concentric cylinders with each wall parallel to the central axis. However, the tubes can also be arranged so that an angle between the graphite basal planes and the tube axis is formed. Such MWNT is known as a stacked cone, Chevron, bamboo, ice cream cone, or piled cone structures. A stacked cone MWNT can reach a diameter of about 100 nm. In spite of these structural variations, all MWNTs are suitable for the present invention as long as they have an excellent thermal conductivity.

Carbon nanotubes used in the present invention can also encapsulate other elements and/or molecules within their enclosed tubular structures. Such elements include Si, Ti, V, Cr, Mn, Fe, Co, Ni, Cu, Y, Zr, Mo, Ta, Au, Th, La, Ce, Pr, Nb, Gd, Th, Dy, Ho, Er, Tm, Yb, Lu, Mo, Pd, Sn, and W. Such molecules include alloys of these elements such as alloys of Cobalt with S, Br, Pb, Pt, Y, Cu, B, and Mg, and compounds such as the carbides (i.e. TiC, MoC, etc.). The present of these elements, alloys and compounds within the core structure of fullerenes and nanotubes can enhance the thermal conductivity of these nanoparticles which then translates to a higher thermal conductive nanofluid when these nanoparticles are suspend in a heat transfer fluid.

Carbon nanoparticles used in the present invention can also be chemically modified and functionalized, such as covalently attached hydrophilic groups for hydrophilic fluids or lipophilic chains for hydrophobic oils. Covalent functionalization of carbon nanoparticles, especially carbon nanotubes and fullerenes, has commonly been accomplished by three different approaches, namely, thermally activated chemistry, electrochemical modification, and photochemical functionalization. The most common methods of thermally activated chemical functionalization are addition reactions on the sidewalls. For example, the extensive treatment of a nanotube with concentrated nitric and sulfuric acids leads to the oxidative opening of the tube caps as well as the formation of holes in the sidewalls and thus produces a nanotube decorated with carboxyl groups, which can be further modified through the creation of amide and ester bonds to generate a vast variety of functional groups. The nanotube molecule can also be modified through addition reactions with various chemical reagents such halogens and ozone. Unlike thermally controlled modification, electrochemical modification of nanotubes can be carried out in more selective and controlled manner. Interestingly, a SWNT can be selectively modified or functionalized either on the cylinder sidewall or the optional end caps. These two distinct structural moieties often display different chemical and physical characteristics.

The term “carbon nanotube” used in the present invention covers all structural variations and modification of SWNT and MWNT discussed hereinabove, including configurations, structural defeats and variations, tube arrangements, chemical modification and functionalization, and encapsulation.

Carbon nanotubes are commercially available from a variety of sources. Single-walled carbon nanotubes can be obtained from Carbolex (Broomall, Pa.), MER Corporation (Tucson, Ariz.), and Carbon Nanotechnologies Incorporation (“CNI”, Houston, Tex.). Multi-walled carbon nanotubes can be obtained from MER Corporation (Tucson, Ariz.) and Helix material solution (Richardson, Tex.). However, the present invention is not limited by the source of carbon nanotubes. In addition, many publications are available with sufficient information to allow one to manufacture nanotubes with desired structures and properties. The most common techniques are arc discharge, laser ablation, chemical vapor deposition, and flame synthesis. In general, the chemical vapor deposition has shown the most promise in being able to produce larger quantities of nanotubes at lower cost. This is usually done by reacting a carbon-containing gas, such as acetylene, ethylene, ethanol, etc., with a metal catalyst particle, such as cobalt, nickel, or ion, at temperatures above 600° C.

The selection of a particular carbon nanoparticle depends on a number of factors. The most important one is that the nanoparticle has to be compatible with an already existing base fluid discussed thereafter. Other factors include heat transfer properties, cost effectiveness, dispersion and settling characteristics. In one embodiment of the present invention, the carbon nanoparticles selected contain predominantly single-walled nanotubes. In one aspect, the carbon nanotube has a carbon content of no less than 60%, preferably no less than 80%, more preferably no less than 90%, still more preferably no less than 95%, still more preferably no less than 98%, and most preferably no less than 99%. In another aspect, the carbon nanotube has a diameter of from about 0.2 nm to about 100 nm, more preferably from about 0.4 nm to about 80 nm, still more preferably from about 0.5 nm to about 60 nm, and most preferably from about 0.5 nm to 50 nm. In yet another aspect, the carbon nanotube is no greater than about 200 micrometers in length, preferably no greater than 100 micrometers, more preferably no greater than about 50 micrometers, and most preferably no greater than 20 micrometers. In yet another aspect, the carbon nanotube has an aspect ratio of no greater than 1,000,000, preferably no greater than 100,000, more preferably no greater than 10,000, still more preferably no greater than 1,000, still more preferably no greater than 500, still more preferably no greater than 200, and most preferably no greater than 100. In yet another aspect, the carbon nanotube has a thermal conductivity of no less than 1.0 W/m·K, preferably no less than 100 W/m·K, more preferably no less than 500 W/m·K, most preferably no less than 1000 W/m·K.

In another embodiment, the carbon particles used in the present invention are multi-walled carbon nanotubes. In one aspect, the carbon nanotube has a carbon content of no less than 60%, preferably no less than 80%, more preferably no less than 90%, still more preferably no less than 95%, still more preferably no less than 98%, and most preferably no less than 99%. In another aspect, the carbon nanotube has a diameter of from about 0.2 nm to about 100 nm, more preferably from about 0.4 nm to about 80 nm, still more preferably from about 0.5 nm to about 60 nm, and most preferably from about 0.5 nm to 50 nm. In yet another aspect, the carbon nanotube is no greater than about 200 micrometers in length, preferably no greater than 100 micrometers, more preferably no greater than about 50 micrometers, and most preferably no greater than 20 micrometers. In yet another aspect, the carbon nanotube has an aspect ratio of no greater than 1,000,000, preferably no greater than 100,000, more preferably no greater than 10,000, still more preferably no greater than 1,000, still more preferably no greater than 500, still more preferably no greater than 200, and most preferably no greater than 100. In yet another aspect, the carbon nanotube has a thermal conductivity of no less than 10 W/m·K, preferably no less than 100 W/m·K, more preferably no less than 500 W/m·K, most preferably no less than 1000 W/m·K.

In yet another embodiment, the carbon particles are diamond nanoparticles, graphite nanoparticles, or fullerenes. In yet another embodiment, the carbon particles are a combination of two or more selected from diamond nanoparticles, graphite nanoparticles, fullerenes, and carbon nanotubes. A combination can be a mixture of two or more nanoparticles of the same type or of different types. For examples, a combination of two nanoparticles can be a mixture of SWNT and MWNT, a mixture of two SWNTs with different properties and/or manufactory methods, a mixture of two MWNT with different properties and/or manufactory methods, a mixture of carbon nanotubes with graphite nanoparticles, a mixture of carbon nanotubes with diamond particles, and a mixture of carbon nanotubes with fullerenes.

### Thermal Transfer Fluid:

The major component of the nanofluid of the present invention is a thermal transfer fluid, which can be selected from a wide variety of well-known organic oils, including petroleum distillates, synthetic petroleum oils, greases, gels, oil-soluble polymer composition, vegetable oils, and combinations thereof. Petroleum distillates, also known as mineral oils, generally include paraffins, naphthenes and aromatics.

Synthetic petroleum oils are the major class of lubricants widely used in various industries. Some examples include alkylaryls such as dodecylbenzenes, tetradecylbenzenes, dinonylbenzenes, and di-(2-ethylhexyl)benzenes; polyphenyls such as biphenyls, terphenyls, and alkylated polyphenyls; fluorocarbons such as polychlorotrifluoroethylenes and copolymers of perfluoroethylene and perfluoropropylene; polymerized olefins such as polybutylenes, polypropylenes, propylene-isobutylene copolymers, chlorinated polybutylenes, poly(1-octenes), and poly(1-decenes); organic phosphates such as triaryl or trialkyl phosphates, tricresyl phosphate, trioctyl phosphate, and diethyl ester of decylphosphonic acid; and silicates such as tetra(2-ethylhexyl) silicate, tetra(2-ethylbutyl) silicate, and hexa(2-ethylbutoxy) disiloxane. Other examples include polyol esters, polyglycols, polyphenyl ethers, polymeric tetrahydrofurans, and silicones.

In one embodiment of the present invention, the thermal transfer fluid is a diester which is formed through the condensation of a dicarboxylic acid, such as adipic acid, azelaic acid, fumaric acid, maleic acid, phtalic acid, sebacic acid, suberic acid, and succinic acid, with a variety of alcohols with both straight, cyclic, and branched chains, such as butyl alcohol, dodecyl alcohol, ethylene glycol diethylene glycol monoether, 2-ethylhexyl alcohol, isodecyl alcohol, hexyl alcohol, pentaerytheritol, propylene glycol, tridecyl alcohol, and trimethylolpropane. Modified dicarboxylic acids, such as alkenyl malonic acids, alkyl succinic acids, and alkenyl succinic acids, can also be used. Specific examples of these esters include dibutyl adipate, diisodecyl azelate, diisooctyl azelate, di-hexyl fumarate, dioctyl phthalate, didecyl phthalate, di(2-ethylhexyl) sebacate, dioctyl sebacate, dicicosyl sebacate, and the 2-ethylhexyl diester of linoleic acid dimer, the complex ester formed by reacting one mole of sebacic acid with two moles of tetraethylene glycol and two moles of 2-ethylhexanoic acid.

In another embodiment, the thermal transfer fluid is a polyalphaolefin which is formed through oligomerization of 1-olefines containing 2 to 32 carbon atoms, or mixtures of such olefins. Some common alphaolefins are 1-octene, 1-decene, and 1-dodecene. Examples of polyalphaolefins include poly-1-octene, poly-1-decene, poly-1-dodecene, mixtures thereof, and mixed olefin-derived polyolefins. Polyalphaolefins are commercially available from various sources, including DURASYN® 162, 164, 166, 168, and 174 (BP-Amoco Chemicals, Naperville, Ill.), which have viscosities of 6, 18, 32, 45, and 460 centistokes, respectively.

In yet another embodiment, the thermal transfer fluid is a polyol ester which is formed through the condensation of a monocarboxylic acid containing 5 to 12 carbons and a polyol and a polyol ether such as neopentyl glycol, trimethylolpropane, pentaerythritol, dipentaerythritol, and tripentaerythritol. Examples of commercially available polyol esters are ROYCO® 500, ROYCO® 555, and ROYCO® 808. ROYCO® 500 contains about 95% of pentaerythritol esters of saturated straight fatty acids with 5 to 10 carbons, about 2% of tricresyl phosphate, about 2% of N-phenyl-alpha-naphthylamine, and about 1% of other minor additives. ROYCO® 808 are about 30 to 40% by weight of trimethylolpropane esters of heptanoic, caprylic and capric acids, 20 to 40% by weight of trimethylolpropane esters of valeric and heptanoic acids, about 30 to 40% by weight of neopentyl glycol esters of fatty acids, and other minor additives. Generally, polyol esters have good oxidation and hydrolytic stability. The polyol ester for use herein preferably has a pour point of about −100° C. or lower to −40° C. and a viscosity of about 2 to 100 centistoke at 100° C.

In yet another embodiment, the thermal transfer fluid is a polyglycol which is an akylene oxide polymer or copolymer. The terminal hydroxyl groups of a polyglycol can be further modified by esterification or etherification to generate another class of known synthetic oils. Interestingly, mixtures of propylene and ethylene oxides in the polymerization process will produce a water soluble lubricant oil. Liquid or oil type polyglycols have lower viscosities and molecular weights of about 400, whereas 3,000 molecular weight polyglycols are viscous polymers at room temperature.

In yet another embodiment, the thermal transfer fluid is a combination of two or more selected from the group consisting of petroleum distillates, synthetic petroleum oils, greases, gels, oil-soluble polymer composition, and vegetable oils. Suitable examples include, but not limited to, a mixture of two polyalphaolefins, a mixture of two polyol esters, a mixture of one polyalphaolefine and one polyol ester, a mixture of three polyalphaolefins, a mixture of two polyalphaolefins and one polyol ester, a mixture of one polyalphaolefin and two polyol esters, and a mixture of three polyol esters. In all the embodiments, the thermal transfer fluid preferably has a viscosity of from about 1 to about 1,000 centistokes, more preferably from about 2 to about 800 centistokes, and most preferably from about 5 to about 500 centistokes.

In yet another embodiment, the thermal transfer fluid is grease which is made by combining a petroleum or synthetic lubricating fluid with a thickening agent. The thickeners are generally silica gel and fatty acid soaps of lithium, calcium, strontium, sodium, aluminum, and barium. The grease formulation may also include coated clays, such as bentonite and hectorite clays coated with quaternary ammonium compounds. Sometimes carbon black is added as a thickener to enhance high-temperature properties of petroleum and synthetic lubricant greases. The addition of organic pigments and powders which include arylurea compounds indanthrene, ureides, and phthalocyanines provide high temperature stability. Sometimes, solid powders such as graphite, molybdenum disulfide, asbestos, talc, and zinc oxide are also added to provide boundary lubrication. Formulating the foregoing synthetic lubricant oils with thickners provides specialty greases. The synthetic lubricant oils include, without limitation, diesters, polyalphaolefins, polyol esters, polyglycols, silicone-diester, and silicone lubricants. Nonmelting thickeners are especially preferred such as copper phthalocyanine, arylureas, indanthrene, and organic surfactant coated clays.

### Surfactant:

A variety of surfactants can be used in the present invention as a dispersant to facilitate uniform dispersion of nanoparticles and to enhance stabilization of such dispersion as well. Typically, the surfactants used in the present invention contain an lipophilic hydrocarbon group and a polar functional hydrophilic group. The polar functional group can be of the class of carboxylate, ester, amine, amide, imide, hydroxyl, ether, nitrile, phosphate, sulfate, or sulfonate. The surfactant can be anionic, cationic, nonionic, zwitterionic, amphoteric and ampholytic.

In one embodiment, the surfactant is anionic, including sulfonates such as alkyl sulfonates, alkylbenzene sulfonates, alpha olefin sulfonates, paraffin sulfonates, and alkyl ester sulfonates; sulfates such as alkyl sulfates, alkyl alkoxy sulfates, and alkyl alkoxylated sulfates; phosphates such as monoalkyl phosphates and dialkyl phosphates; phosphonates; carboxylates such as fatty acids, alkyl alkoxy carboxylates, sarcosinates, isethionates, and taurates. Specific examples of carboxylates are sodium cocoyl isethionate, sodium methyl oleoyl taurate, sodium laureth carboxylate, sodium trideceth carboxylate, sodium lauryl sarcosinate, lauroyl sarcosine, and cocoyl sarcosinate. Specific examples of sulfates include sodium dodecyl sulfate, sodium lauryl sulfate, sodium laureth sulfate, sodium trideceth sulfate, sodium tridecyl sulfate, sodium cocyl sulfate, and lauric monoglyceride sodium sulfate.

Suitable sulfonate surfactants include alkyl sulfonates, aryl sulfonates, monoalkyl and dialkyl sulfosuccinates, and monoalkyl and dialkyl sulfosuccinamates. Each alkyl group independently contains about two to twenty carbons and can also be ethoxylated with up to about 8 units, preferably up to about 6 units, on average, e.g., 2, 3, or 4 units, of ethylene oxide, per each alkyl group. Illustrative examples of alky and aryl sulfonates are sodium tridecyl benzene sulfonate and sodium dodecylbenzene sulfonate.

Illustrative examples of sulfosuccinates include, but not limited to, dimethicone copolyol sulfosuccinate, diamyl sulfosuccinate, dicapryl sulfosuccinate, dicyclohexyl sulfosuccinate, diheptyl sulfosuccinate, dihexyl sulfosuccinate, diisobutyl sulfosuccinate, dioctyl sulfosuccinate, C12-15 pareth sulfosuccinate, cetearyl sulfosuccinate, cocopolyglucose sulfosuccinate, cocoyl butyl gluceth-10 sulfosuccinate, deceth-5 sulfosuccinate, deceth-6 sulfosuccinate, dihydroxyethyl sulfosuccinylundecylenate, hydrogenated cottonseed glyceride sulfosuccinate, isodecyl sulfosuccinate, isostearyl sulfosuccinate, laureth-5 sulfosuccinate, laureth sulfosuccinate, laureth-12 sulfosuccinate, laureth-6 sulfosuccinate, laureth-9 sulfosuccinate, lauryl sulfosuccinate, nonoxynol-10 sulfosuccinate, oleth-3 sulfosuccinate, oleyl sulfosuccinate, PEG-10 laurylcitrate sulfosuccinate, sitosereth-14 sulfosuccinate, stearyl sulfosuccinate, tallow, tridecyl sulfosuccinate, ditridecyl sulfosuccinate, bisglycol ricinosulfosuccinate, di(1,3-di-methylbutyl) sulfosuccinate, and silicone copolyol sulfosuccinates. The structures of silicone copolyol sulfosuccinates are set forth in U.S. Pat. Nos. 4,717,498 and 4,849,127, herein incorporated by reference.

Illustrative examples of sulfosuccinamates include, but not limited to, lauramido-MEA sulfosuccinate, oleamido PEG-2 sulfosuccinate, cocamido MIPA-sulfosuccinate, cocamido PEG-3 sulfosuccinate, isostearamido MEA-sulfosuccinate, isostearamido MIPA-sulfosuccinate, lauramido MEA-sulfosuccinate, lauramido PEG-2 sulfosuccinate, lauramido PEG-5 sulfosuccinate, myristamido MEA-sulfosuccinate, oleamido MEA-sulfosuccinate, oleamido PIPA-sulfosuccinate, oleamido PEG-2 sulfosuccinate, palmitamido PEG-2 sulfosuccinate, palmitoleamido PEG-2 sulfosuccinate, PEG-4 cocamido MIPA-sulfosuccinate, ricinoleamido MEA-sulfosuccinate, stearamido MEA-sulfosuccinate, stearyl sulfosuccinamate, tallamido MEA-sulfosuccinate, tallow sulfosuccinamate, tallowamido MEA-sulfosuccinate, undecylenamido MEA-sulfosuccinate, undecylenamido PEG-2 sulfosuccinate, wheat germamido MEA-sulfosuccinate, and wheat germamido PEG-2 sulfosuccinate.

Some examples of commercial sulfonates are AEROSOL® OT-S, AEROSOL® OT-MSO, AEROSOL® TR70% (Cytec inc, West Paterson, N.J.), NaSul CA-HT3 (King industries, Norwalk, Conn.), and C500 (Crompton Co, West Hill, Ontario, Canada). AEROSOL® OT-S is sodium dioctyl sulfosuccinate in petroleum distillate. AEROSOL® OT-MSO also contains sodium dioctyl sulfosuccinate. AEROSOL® TR70% is sodium bistridecyl sulfosuccinate in mixture of ethanol and water. NaSul CA-HT3 is calcium dinonylnaphthalene sulfonate/carboxylate complex. C500 is an oil soluble calcium sulfonate.

For an anionic surfactant, the counter ion is typically sodium but may alternatively be potassium, lithium, calcium, magnesium, ammonium, amines (primary, secondary, tertiary or quandary) or other organic bases. Exemplary amines include isopropylamine, ethanolamine, diethanolamine, and triethanolamine. Mixtures of the above cations may also be used.

In another embodiment, the surfactant is cationic, including primarily organic amines, primary, secondary, tertiary or quaternary. For a cationic surfactant, the counter ion can be chloride, bromide, methosulfate, ethosulfate, lactate, saccharinate, acetate and phosphate. Examples of cationic amines include polyethoxylated oleyl/stearyl amine, ethoxylated tallow amine, cocoalkylamine, oleylamine, and tallow alkyl amine.

Examples of quaternary amines with a single long alkyl group are cetyl trimethyl ammonium bromide (“CETAB”), dodecyltrimethylammonium bromide, myristyl trimethyl ammonium bromide, stearyl dimethyl benzyl ammonium chloride, oleyl dimethyl benzyl ammonium chloride, lauryl trimethyl ammonium methosulfate (also known as cocotrimonium methosulfate), cetyl-dimethyl hydroxyethyl ammonium dihydrogen phosphate, bassuamidopropylkonium chloride, cocotrimonium chloride, distearyldimonium chloride, wheat germ-amidopropalkonium chloride, stearyl octyidimonium methosulfate, isostearaminopropalkonium chloride, dihydroxypropyl PEG-5 linoleammonium chloride, PEG-2 stearmonium chloride, behentrimonium chloride, dicetyl dimonium chloride, tallow trimonium chloride and behenamidopropyl ethyl dimonium ethosulfate.

Examples of quaternary amines with two long alkyl groups are distearyldimonium chloride, dicetyl dimonium chloride, stearyl octyldimonium methosulfate, dihydrogenated palmoylethyl hydroxyethylmonium methosulfate, dipalmitoylethyl hydroxyethylmonium methosulfate, dioleoylethyl hydroxyethylmonium methosulfate, and hydroxypropyl bisstearyldimonium chloride.

Quaternary ammonium compounds of imidazoline derivatives include, for example, isostearyl benzylimidonium chloride, cocoyl benzyl hydroxyethyl imidazolinium chloride, cocoyl hydroxyethylimidazolinium PG-chloride phosphate, and stearyl hydroxyethylimidonium chloride. Other heterocyclic quaternary ammonium compounds, such as dodecylpyridinium chloride, can also be used.

In yet another embodiment, the surfactant is nonionic, including polyalkylene oxide carboxylic acid esters, fatty acid esters, fatty alcohols, ethoxylated fatty alcohols, poloxamers, alkanolamides, alkoxylated alkanolamides, polyethylene glycol monoalkyl ether, and alkyl polysaccharides. Polyalkylene oxide carboxylic acid esters have one or two carboxylic ester moieties each with about 8 to 20 carbons and a polyalkylene oxide moiety containing about 5 to 200 alkylene oxide units. A ethoxylated fatty alcohol contains an ethylene oxide moiety containing about 5 to 150 ethylene oxide units and a fatty alcohol moiety with about 6 to about 30 carbons. The fatty alcohol moiety can be cyclic, straight, or branched, and saturated or unsaturated. Some examples of ethoxylated fatty alcohols include ethylene glycol ethers of oleth alcohol, steareth alcohol, lauryl alcohol and isocetyl alcohol. Poloxamers are ethylene oxide and propylene oxide block copolymers, having from about 15 to about 100 moles of ethylene oxide. Alkyl polysaccharide (“APS”) surfactants (e.g. alkyl polyglycosides) contain a hydrophobic group with about 6 to about 30 carbons and a polysaccharide (e.g., polyglycoside) as the hydrophilic group. An example of commercial nonionic surfactant is FOA-5 (Octel Starreon LLC., Littleton, Colo.).

Specific examples of suitable nonionic surfactants include alkanolamides such as cocamide diethanolamide (“DEA”), cocamide monoethanolamide (“MEA”), cocamide monoisopropanolamide (“MIPA”), PEG-5 cocamide MEA, lauramide DEA, and lauramide MEA; alkyl amine oxides such as lauramine oxide, cocamine oxide, cocamidopropylamine oxide, and lauramidopropylamine oxide; sorbitan laurate, sorbitan distearate, fatty acids or fatty acid esters such as lauric acid, isostearic acid, and PEG-150 distearate; fatty alcohols or ethoxylated fatty alcohols such as lauryl alcohol, alkylpolyglucosides such as decyl glucoside, lauryl glucoside, and coco glucoside.

In yet another embodiment, the surfactant is zwitterionic, which has both a formal positive and negative charge on the same molecule. The positive charge group can be quaternary ammonium, phosphonium, or sulfonium, whereas the negative charge group can be carboxylate, sulfonate, sulfate, phosphate or phosphonate. Similar to other classes of surfactants, the hydrophobic moiety may contain one or more long, straight, cyclic, or branched, aliphatic chains of about 8 to 18 carbon atoms. Specific examples of zwitterionic surfactants include alkyl betaines such as cocodimethyl carboxymethyl betaine, lauryl dimethyl carboxymethyl betaine, lauryl dimethyl alpha-carboxyethyl betaine, cetyl dimethyl carboxymethyl betaine, lauryl bis-(2-hydroxyethyl)carboxy methyl betaine, stearyl bis-(2-hydroxypropyl)carboxymethyl betaine, oleyl dimethyl gamma-carboxypropyl betaine, and lauryl bis-(2-hydroxypropyl)alphacarboxy-ethyl betaine, amidopropyl betaines; and alkyl sultaines such as cocodimethyl sulfopropyl betaine, stearyidimethyl sulfopropyl betaine, lauryl dimethyl sulfoethyl betaine, lauryl bis-(2-hydroxyethyl)sulfopropyl betaine, and alkylamidopropylhydroxy sultaines.

In yet another embodiment, the surfactant is amphoteric. Suitable examples of suitable amphoteric surfactants include ammonium or substituted ammonium salts of alkyl amphocarboxy glycinates and alkyl amphocarboxypropionates, alkyl amphodipropionates, alkyl amphodiacetates, alkyl amphoglycinates, and alkyl amphopropionates, as well as alkyl iminopropionates, alkyl iminodipropionates, and alkyl amphopropylsulfonates. Specific examples are cocoamphoacetate, cocoamphopropionate, cocoamphodiacetate, lauroamphoacetate, lauroamphodiacetate, lauroamphodipropionate, lauroamphodiacetate, cocoamphopropyl sulfonate, caproamphodiacetate, caproamphoacetate, caproamphodipropionate, and stearoamphoacetate.

In yet another embodiment, the surfactant is a polymer such as N-substituted polyisobutenyl succinimides and succinates, alkyl methacrylate vinyl pyrrolidinone copolymers, alkyl methacrylate-dialkylaminoethyl methacrylate copolymers, alkylmethacrylate polyethylene glycol methacrylate copolymers, and polystearamides.

In yet another embodiment, the surfactant is an oil-based dispersant, which includes alkylsuccinimide, succinate esters, high molecular weight amines, and Mannich base and phosphoric acid derivatives. Some specific examples are polyisobutenyl succinimide-polyethylenepolyamine, polyisobutenyl succinic ester, polyisobutenyl hydroxybenzyl-polyethylenepolyamine, and bis-hydroxypropyl phosphorate.

In yet another embodiment, the surfactant used in the present invention is a combination of two or more selected from the group consisting of anionic, cationic, nonionic, zwitterionic, amphoteric, and ampholytic surfactants. Suitable examples of a combination of two or more surfactants of the same type include, but not limited to, a mixture of two anionic surfactants, a mixture of three anionic surfactants, a mixture of four anionic surfactants, a mixture of two cationic surfactants, a mixture of three cationic surfactants, a mixture of four cationic surfactants, a mixture of two nonionic surfactants, a mixture of three nonionic surfactants, a mixture of four nonionic surfactants, a mixture of two zwitterionic surfactants, a mixture of three zwitterionic surfactants, a mixture of four zwitterionic surfactants, a mixture of two amphoteric surfactants, a mixture of three amphoteric surfactants, a mixture of four amphoteric surfactants, a mixture of two ampholytic surfactants, a mixture of three ampholytic surfactants, and a mixture of four ampholytic surfactants.

Suitable examples of a combination of two surfactants of the different types include, but not limited to, a mixture of one anionic and one cationic surfactant, a mixture of one anionic and one nonionic surfactant, a mixture of one anionic and one zwitterionic surfactant, a mixture of one anionic and one amphoteric surfactant, a mixture of one anionic and one ampholytic surfactant, a mixture of one cationic and one nonionic surfactant, a mixture of one cationic and one zwitterionic surfactant, a mixture of one cationic and one amphoteric surfactant, a mixture of one cationic and one ampholytic surfactant, a mixture of one nonionic and one zwitterionic surfactant, a mixture of one nonionic and one amphoteric surfactant, a mixture of one nonionic and one ampholytic surfactant, a mixture of one zwitterionic and one amphoteric surfactant, a mixture of one zwitterionic and one ampholytic surfactant, and a mixture of one amphoteric and one ampholytic surfactant. A combination of two or more surfactants of the same type, e.g., a mixture of two anionic surfactants, is also included in the present invention.

### Other Chemical Additives:

The nanofluids of the present invention may also contain one or more other chemicals to provide other desired chemical and physical properties and characteristics. Such chemical additives include antioxidants, corrosion inhibitors, copper corrosion inhibitors, friction modifiers, viscosity improvers, pour point depressants, and seal-swelling agents.

Suitable antioxidants include phenolic antioxidants, aromatic amine antioxidants, sulfurized phenolic antioxidants, and organic phosphates. Examples include 2,6-di-tert-butylphenol, liquid mixtures of tertiary butylated phenols, 2,6-di-tert-butyl-4-methylphenol, 4,4′-methylenebis(2,6-di-tert-butylphenol), 2,2′-methylenebis(4-methyl-6-tert-butylphenol), mixed methylene-bridged polyalkyl phenols, 4,4′-thiobis(2-methyl-6-tert-butylphenol), N,N′-di-sec-butyl-p-phenylenediamine, 4-isopropylaminodiphenylamine, phenyl-alpha-naphthylamine, and phenyl-beta-naphthylamine.

Suitable corrosion inhibitors include dimer and trimer acids, such as those produced from tall oil fatty acids, oleic acid, or linoleic acid; alkenyl succinic acid and alkenyl succinic anhydride corrosion inhibitors, such as tetrapropenylsuccinic acid, tetrapropenylsuccinic anhydride, tetradecenylsuccinic acid, tetradecenylsuccinic anhydride, hexadecenylsuccinic acid, hexadecenylsuccinic anhydride; and the half esters of alkenyl succinic acids having 8 to 24 carbon atoms in the alkenyl group with alcohols such as the polyglycols. Other suitable corrosion inhibitors include ether amines; acid phosphates; amines; polyethoxylated compounds such as ethoxylated amines, ethoxylated phenols, and ethoxylated alcohols; imidazolines; aminosuccinic acids or derivatives thereof.

Suitable copper corrosion inhibitors include thiazoles such as 2-mercapto benzothiazole; triazoles such as benzotriazole, tolyltriazole, octyltriazole, decyltriazole, and dodecyltriazole; and thiadiazoles such as 2-mercapto-5-hydrocarbylthio-1,3,4-thiadiazoles, 2-mercapto-5-hydrocarbyldithio-1,3,4-thiadiazoles, 2,5-bis(hydrocarbylthio)-1,3,4-thiadiazoles, and 2,5-(bis)hydrocarbyldithio)-1,3,4-thiadiazoles.

Suitable friction modifiers include aliphatic amines, aliphatic fatty acid amides, aliphatic carboxylic acids, aliphatic carboxylic esters, aliphatic carboxylic ester-amides, aliphatic phosphonates, aliphatic phosphates, aliphatic thiophosphonates, and aliphatic thiophosphates, wherein the aliphatic group usually contains above about eight carbon atoms so as to render the compound suitably oil soluble. Also suitable are aliphatic substituted succinimides formed by reacting one or more aliphatic succinic acids or anhydrides with ammonia.

Suitable viscosity improvers include olefin copolymers, polymethacrylates, hydrogenated styrene-diene, and styrene-polyester polymers. Also suitable are acrylic polymers such as polyacrylic acid and sodium polyacrylate; high-molecular-weight polymers of ethylene oxide; cellulose compounds such as carboxymethylcellulose; polyvinyl alcohol; polyvinyl pyrrolidone; xanthan gums and guar gums; polysaccharides; alkanolamides; amine salts of polyamide; hydrophobically modified ethylene oxide urethane; silicates; and fillers such as mica, silicas, cellulose, wood flour, clays (including organoclays) and nanoclays; and resin polymers such as polyvinyl butyral resins, polyurethane resins, acrylic resins and epoxy resins.

Most pour point depressants are organic polymers, although some nonpolymeric substances have been shown to be effective. Both nonpolymeric and polymeric depressants can be used in the present invention. Examples include alkylnaphthalenes, polymethacrylates, polyfumarates, styrene esters, oligomerized alkylphenols, phthalic acid esters, ethylenevinyl acetate copolymers, and other mixed hydrocarbon polymers. The treatment level of these additives is usually low. In nearly all cases, there is an optimum concentration above and below which pour point depressants become less effective.

Suitable seal-swelling agents include dialkyl diesters of adipic, azelaic, sebacic, and phthalic acids. Examples of such materials include n-octyl, 2-ethylhexyl, isodecyl, and tridecyl diesters of adipic acid, azelaic acid, and sebacic acid, and n-butyl, isobutyl, pentyl, hexyl, heptyl, octyl, nonyl, decyl, undecyl, dodecyl, and tridecyl diesters of phthalic acid. Also useful are aromatic hydrocarbons with suitable viscosity.

In addition to the chemicals listed, many other known types of additives such as dyes, foam inhibitors, demulsifiers, and air release agents, can also be included in finished compositions produced and/or used in the practice of the present invention. In general, the additive components are employed in nanofluids in minor amounts sufficient to enhance the performance characteristics and properties of the base fluid. The amounts will thus vary in accordance with such factors as the viscosity characteristics of the base fluid employed, the viscosity characteristics desired in the finished fluid, the service conditions for which the finished fluid is intended, and the performance characteristics desired in the finished fluid.

### Physical Agitation:

The nanofluid of the present invention is prepared by dispersing a mixture of the appropriate surfactant, lubricant, carbon nanomaterials, and other chemical additives using a physical method to form a stable suspension of carbon nanoparticles in a thermal transfer fluid. A variety of physical mixing methods can be used in the present invention, including high shear mixing, such as with a high speed mixer, homogenizers, microfluidizers, high impact mixing, and ultrasonication methods. Among these methods, unltrasonication is the least destructive to the structures of carbon nanoparticles. Ultrasonication can be done either in the bath-type ultrasonicator, or by the tip-type ultrasonicator. Typically, tip-type ultrasonication is for applications which require higher energy output. Ultrasonication at a medium-high instrumental intensity for up to 60 minutes, and usually in a range of from 10 to 30 minutes is desired to achieve better homogeneity. Additional, the mixture is sonicated intermittently to avoid overheating. It is well known that overheating can break the carbon nanotubes to lose conjugated bonds and hence lose their beneficial physical properties. The terms “ultrasonication” and “sonication” are used interchangeably throughout the instant disclosure.

The raw material mixture may be pulverized by any suitable known dry or wet grinding method. One grinding method includes pulverizing the raw material mixture in the fluid mixture of the present invention to obtain a concentrate, and the pulverized product may then be dispersed further in a liquid medium with the aid of the dispersants described above. However, pulverization or milling often reduces the carbon nanotube average aspect ratio.

It will be appreciated that the individual components can be separately blended into the base fluid or can be blended therein in various subcombinations, if desired. Ordinarily, the particular sequence of such blending steps is not critical. Moreover, such components can be blended in the form of separate solutions in a diluent. It is preferable, however, to blend the components used in the form of an additive concentrate as this simplifies the blending operations, reduces the likelihood of blending errors, and takes advantage of the compatibility and solubility characteristics afforded by the overall concentrate.

### Nanolubricants:

The nanolubricant of the present invention is a dispersion of carbon nanoparticles in a thermal transfer fluid in the present of at least one surfactant. The surfactants are used to stabilize the nanoparticle dispersion. In one aspect, the thermal transfer fluid of the nanolubricant is selected from petroleum distillates, synthetic petroleum oils, greases, gels, oil-soluble polymer composition, vegetable oils, and combinations thereof. The thermal transfer fluid is preferably synthetic petroleum oils, such as polyalphaolefins, polyol esters, or combinations thereof. The nanolubricant contains from about 40 to 99% by weight of a thermal transfer fluid, preferably 50 to about 98%, more preferably 60 to about 97%, still more preferably from about 70 to about 96%, still more preferably from about 80 to about 95%, and most preferably from about 85 to about 96%. The thermal transfer fluid preferably has a viscosity of from about 2 to about 800 centistokes, more preferably from about 4 to about 500 centistokes, and most preferably from about 10 to about 200 centistokes.

In another aspect, the carbon nanoparticles of the nanolubricant are selected from diamond nanoparticles, graphite nanoparticles, fullerenes, carbon nanotubes, and combinations thereof. The nanolubricant contains no greater than about 30% by weight of carbon nanoparticles, preferably no greater than 15%, more preferably no greater than about 10%, most preferably no greater than about 5%.

In yet another aspect, the nanolubricant contains at least one surfactant as a dispersant agent to stabilize the nanoparticle suspension. The surfactant is selected from anionic, cationic, nonionic, zwitterionic, amphoteric, ampholytic surfactants, and combinations thereof. The nanolubricant contains from about 0.1 to about 30% by weight of surfactants, preferably from about 1 to about 20%, more preferably from about 1 to 15%, and most preferably from about 1 to 10%. Optionally, the mixture can also contain other additives to enhance chemical and/or physical properties. Typically, the amount of these additives together is no greater than 10% by weight of the nanolubricant. In any case, the total amount of all the ingredients of the nanolubricant together equals to 100%.

The nanolubricant of the present invention can be prepared by three different dispersing methods. In the first process, dry carbon nanoparticles are dispersed directly into a thermal transfer fluid and other additives in the present of surfactants with a physical agitation, such as ultrasonication. Preferably, the ultrasonication is operated in intermittent mode to avoid causing structural damage to carbon nanoparticles. The carbon nanoparticles-containing mixture is energized for a predetermined period of time with a break in between. Each energizing period is no more than about 30 min, preferably no more than about 15 min, more preferably no more than 10 min, and most preferably no more than 5 min. The break between ultrasonication pulses provides the opportunities for the energized carbon nanoparitcles to dissipate the energy. The break is preferably no less than about 1 min, more preferably no less than about 2 min, yet more preferably no less than about 5 min, and most preferably from about 5 to about 10 min. The order of addition of the individual components is not critical for the practice of the invention. However, it is desired to the nanofluid composition be thoroughly blended and that all the components be completely dissolved to provide optimum performance.

The second dispersing process is carried out in three stages. At first, carbon nanoparticles are dispersed into a volatile solvent to form an intermediate dispersion with help of a physical agitation, such as ultrasonication. Suitable volatile solvents are organic solvents, such as halogenated solvents such as chloroform, methylene chloride, and 1,2-dichloroethane; ethers such as diethyl ether; carboxylic esters such as ethyl acetate; carbonyl solvents such as acetone; nitriles such as acetonitrile; amides such as dimethylformide; alcohols such methanol, ethanol, and isopropanol, and combinations thereof. Preferably, the solvent used in the present invention has a boiling point less than 300° C., less than 200° C., or 150° C. At second, a thermal transfer fluid, surfactants, and other additives are added into this intermediate dispersion and mixed thoroughly with a physical agitation, such as ultrasonication. At this step, the order of addition of the individual components is not critical for the practice of the invention. However, it is desired to the nanofluid composition be thoroughly blended and that all the components be completely dissolved to provide optimum performance. At last, the volatile solvent is removed under vacuum to produce a uniformly dispersed nanofluid. Heating can also be applied to accelerate the solvent removal process. When ultrasonication is used as a dispersion method, it is preferably to be operated in an intermittent mode aforementioned to avoid causing structural damages to the nanoparticles used.

The third dispersing process is performed at elevated temperatures. Prior to the addition of carbon nanoparticles, a homogeneous mixture or solution of surfactants and other additives in a thermal transfer fluid is prepared. Heating and a physical agitation, such as mechanical stirring, can also be applied to help the preparation of the mixture. At this step, the order of addition of the individual components is not critical for the practice of the invention. However, it is desired to the nanofluid composition be thoroughly blended and that all the components be completely dissolved to provide optimum performance. The dispersion of carbon nanoparticles is then carried out at an elevated temperature range, at which no adversary reactions occur between the chemicals and carbon nanoparticles, and of which the highest temperature is below the boiling point of any chemical in the thermal transfer fluid. The operational temperature range in the present invention is preferably between about 50 to about 300° C., more preferably between about 70 to about 275° C., yet more preferably between 80 to 250° C., and most preferably from about 90 to 225° C. During the dispersion process, carbon nanoparticles are added slowly in small portion over a predefined period of time in the present of a physical agitation, such as mechanical stirring. The period of time is determined based on factors such as the scale of the production and the efficiency of mixing, including, but not limited to, 1 min, 2 min, 5 min, 10 min, 20 min, 30 min, 40 min, 50 min, 1 hr, and longer. After addition, the mixture is blended further at an elevated temperature or room temperature to ensure the homogeneity of the dispersion. The nanofluid thus prepared is stable even after cooling down to room temperature. This high temperature dispersion process provides several advantages over the current available technologies. The dispersion process is simple, economical, and environmental friendly. The process is also highly scalable and can be readily adapted for large industrial-scale production.

### Nanogreases:

The nanogrease of the present invention is a dispersion of carbon nanoparticles in a thermal transfer fluid in the present of at least one surfactant. The nanogrease is prepared by blending a mixture of a thermal transfer fluid, carbon nanoparticles, at lease one surfactant, and other chemical additives together with help of a physical agitation. The thermal transfer fluid contains one or more organic oils. In one aspect, the thermal transfer fluid of the nanolubricant is selected from petroleum distillates, synthetic petroleum oils, greases, gels, oil-soluble polymer composition, vegetable oils, and combinations thereof. Preferably, the thermal transfer fluid is synthetic petroleum oils, such as polyalphaolefins, polyol esters, and combinations thereof. The nanogrease contains from about 60 to about 99% by weight of a thermal transfer fluid, preferably from about 70 to about 98%, more preferably from about 80 to about 96%, and most preferably from about 85 to about 96%. The thermal transfer fluid preferably has a viscosity of from about 2 to about 800 centistokes, more preferably from about 4 to about 500 centistokes, and most preferably from about 10 to about 200 centistokes.

In another aspect, the carbon nanoparticles of the nanogrease are selected from diamond nanoparticles, graphite nanoparticles, fullerenes, carbon nanotubes, and combinations thereof. The nanogrease contains no greater than about 30% by weight of carbon nanoparticles, preferably no greater than 15%, more preferably no greater than about 10%, most preferably no greater than about 5%.

In yet another aspect, the nanogrease contains at least one surfactant as a dispersant agent to stabilize the nanoparticle suspension. The surfactant is selected from anionic, cationic, nonionic, zwitterionic, amphoteric, ampholytic surfactants, and combinations thereof. The nanogrease contains from about 0.1 to about 30% by weight of the surfactant, preferably from about 1 to about 20%, more preferably from about 1 to 15%, and most preferably from about 1 to 10%. Optionally, the mixture can also contain other additives to enhance chemical and/or physical properties. Typically, the amount of these additives together is no greater than 10% by weight of the nanogrease. In any case, the total amount of all the ingredients of the nanogrease together equals to 100%.

In yet another aspect, the nanogrease of the present invention is prepared by dispersing dry carbon nanoparticles directly into a mixture of a thermal transfer fluid and other additives in the present of at least one surfactant with a physical agitation, such as a three roll milling machine, to produce a homogeneous and stable nanoparticule dispersion.

The nanogrease containing carbon nanoparticles has remarkable heat resistance, thermal conductivity, and stability. Typically, the nanogrease prepared from a thermal transfer fluid with a viscosity of below 50 centistokes has a dropping point of greater than 260° C. as measured according to ASTM, an oil separation degree of no greater than 5%, a thermal conductivity of no less than 5 W/m·K. The dispersion property of a nanogrease is affected by the structural properties of carbon nanotubes and the manufacture method. In general, MWNT with smaller diameters shows better dispersion property.

### EXAMPLES

Carbon nanotubes from several commercial sources were used in the following examples and their information is summarized in Table 1.

TABLE 1

| Abbreviation | Product Information | Commercial Source |
|---|---|---|
| MWNT-HMSI | MWNT with a diameter | Helix Material Solution Inc |
| | of 10–20 nm and a | |
| | length of 0.5–40 | |
| | micrometers | |
| MWNT-MER | MWNT with a diameter | Materials and Electrochemical |
| | of 140 ± 30 nm, a | Research Corporation |
| | length of 7 ± 2 | |
| | micrometers, and a | |
| | purity of over 90%. | |
| D-SWNT-CNI | D-SWNT bundles | Carbon Nanotechnologies Inc. |
| F-SWNT-CNI | Purified F-SWNT | Carbon Nanotechnologies Inc. |

### Example I

### Acid Treated Carbon Nanotubes

A suspension of carbon nanotubes (5% by weight) in sulfuric acid/nitrate acid (3:1) was heated at 110° C. under nitrogen for about 3 days. The suspension was then diluted with deionized water and filtered to remove the acids. After further washed with acetone and deionized water, the solid was dried in an oven at about 60 to 70° C. overnight.

### Example II

### A Nanofluid of MWNT in ROYCO® 500

A MWNT nanofluid in ROYCO® 500 was prepared by mixing dry carbon nanotubes, a dispersant, thermal transfer fluid together according to the proportions specified in the table below. The mixture was then sonicated using Digital Sonifier Model 102 C by Branson Ultrasonics Corporation (Monroe Township, N.J.). The sonication was carried out sporadically (i.e., intermittently) at room temperature for 15 to 30 min, to avoid damaging and altering the structures of carbon nanotubes. Typically, the carbon nanoparticles-containing mixture was energized for 1-2 min with a break about 5-10 min in between.

| Component | Description | Weight |
|---|---|---|
| Carbon Nanotube | MWNT-HMSI, surface | 0.1% |
| | untreated | |
| Surfactant | AEROSOL ® OT-MSO | 5.0% |
| Heat transfer fluid | ROYCO ® 500 | 94.9% |
| Sonication | 15 min in an intermittent mode | |
| Dispersion and | Dispersion was very good, | |
| stability | stability lasted more | |
| | than one month. | |

### Example III

### A Nanofluid of MWNT in DURASYN® 166

A MWNT nanofluid in DURASYN® 166 was prepared according to the procedure described in Example II.

| Component | Description | Weight |
|---|---|---|
| Carbon nanotube | MWNT-HMSI, surface | 0.1% |
| | untreated | |
| Surfactant | AEROSOL ® OT-MSO | 5% |
| Heat transfer fluid | DURASYN ® 166 | 94.9% |
| Sonication | 15 min in an intermittent mode | |
| Dispersion and | Dispersion was very good, | |
| stability | stability lasted more | |
| | than one month. | |

### Example IV

### A Nanofluid of MWNT in ROYCO® 500

The MWNT used in this example was obtained from Materials and Electrochemical Research Corporation (“MER”). Those carbon nanotubes were produced by chemical vapor deposition and have a diameter of 140±30 nm, a length of 7±2 micron, and a purity of over 90%. A MWNT nanofluid in ROYCO® 500 was prepared according to the procedure described in Example II.

| Component | Description | Weight |
|---|---|---|
| Carbon nanotube | MWNT-MER, surface | 0.1% |
| | untreated | |
| Surfactant | AEROSOL ® OT-MSO | 5.0% |
| Heat transfer fluid | ROYCO ® 500 | 94.9% |
| Sonication | 15 min in an intermittent mode | |
| Dispersion and | Dispersion was very good, | |
| stability | stability lasted more | |
| | than one month. | |

### Example V

### A Nanofluid of MWNT in ROYCO® 500

A MWNT nanofluid in ROYCO® 500 was prepared according to the procedure described in Example II.

| Component | Description | Weight |
|---|---|---|
| Carbon nanotube | MWNT-HMSI, surface | 0.1% |
| | untreated | |
| Surfactant | AEROSOL ® TR70% | 5.0% |
| Heat transfer fluid | ROYCO ® 500 | 94.9% |
| Sonication | 15 min in an intermittent mode | |
| Dispersion and | Dispersion was very good, | |
| stability | stability lasted more | |
| | than one month. | |

### Example VI

### A Nanofluid of D-SWNT in DURASYN® 166

A MWNT nanofluid in DURASYN®166 was prepared according to the procedure described in Example II.

| Component | Description | Weight |
|---|---|---|
| Carbon nanotube | D-SWNT-CNI, surface | 3% |
| | untreated | |
| Surfactant | Chevron oronite, OLOA 11002 | 5% |
| Heat transfer fluid | DURASYN ® 166 | 92% |
| Sonication | 30 min in an intermittent mode | |
| Dispersion and | Dispersion was very good, | |
| stability | stability lasted more | |
| | than one month. | |

### Example VII

### A Nanofluid of D-SWNT in DURASYN® 166

In this experiment, a dry carbon nanotube (3 g) was first dispersed in chloroform (100 ml) with help of a physical agitation, such as intermittent ultrasonication. Then, polyalphaolefin (DURASYN® 166), a synthetic oil (92 g, 110 ml), and OLOA 11002 surfactant (5 g) were added to this chloroform dispersion and blended thoroughly with help of a physical agitation, such as intermittent ultrasonication. Chloroform was removed by distillation with mechanical stirring. Final drying was done under heated dynamic vacuum.

| Component | Description | Weight |
|---|---|---|
| Carbon nanotube | D-SWNT, surface untreated | 3% |
| Surfactant | Chevron oronite, OLOA 11002 | 5% |
| Heat transfer fluid | DURASYN ® 166 | 92% |
| | containing synthetic | |
| | polyalphaolefin oils | |
| Sonication | 30 min in an intermittent mode | |
| Dispersion and | Dispersion is very good, | |
| stability | stability lasts more than | |
| | three month. | |

### Example VIII

### Characterization of Carbon Nanotube-Containing Nanofluids

To characterize the nanofluids of the present invention, three parameters were determined, including total acid number, pour point, and viscosity. Total acid number (“TAN”) per ASTM D664 was determined for the oil based fluids (DURASYN®166 and ROYCO® 808 oils). TAN is to quantify the amount of acidic constituents present in a petroleum product and expressed in milligrams of potassium hydroxide needed to neutralize the acidic constituents in one gram of nanofluid. As shown in Table 2, all nanofluids tested have very low TAN, indicating that carbon nanotubes have low chemical activity and are stable and compatible with the two synthetic petroleum oils.

The viscosities of the nanofluids were determined at 40 and 100° C. per ASTM D445. For comparison, the viscosities of original ROYCO® 808 and DURASYN® 166 oils were also measured. ROYCO® 808 and DURASYN® 166 oils have viscosities of 2-3 and 5-6 centistokes, respectively. As shown in Table 2, carbon nanotubes have dramatic affect on the viscosity of oil-based nanofluids. Addition of 0.25% by weight of SWNT in ROYCO® 808 increases the viscosity to 53-54 centistokes at 40° C.

Pour point is the lowest temperature at which a fluid remains pourable. Pour points were determined per ASTM D97 for the ROYCO® 808 and DURASYN® 166 based nanofluids. As shown in Table 2, all nanofluids tested have relatively low pour points.

TABLE 2
Characterization of Carbon Nanotube-Containing Nanofluids.

| | Total | Vis at | Vis at | Pour |
|---|---|---|---|---|
| | Acid No. | 40° C. | 100° C. | Point |
| Fluid | (mg KOH/g) | (cSt.) | (cSt.) | (° C.) |
| ROYCO ® 808 + 0.25% | 0.08 | 53.88 | 8.16 | <−63 |
| D-SWNT-CNI | | | | |
| ROYCO ® 808 + 0.25% | 0.09 | 54.11 | 11.48 | <−63 |
| D-SWNT-CNI DMF | | | | |
| DURASYN ® 166 (PAO) + | <0.05 | 392.54 | 56.05 | <−63 |
| 0.5% D-SWNT-CNI | | | | |

### Example IX

### Preparation of Nanogreases

Lubricating nanogreases were prepared using carbon nanoparticles as a thickener. The following is a typical procedure for preparing a nanogrease. A mixture of a polyalphaolefin with a viscosity of 6 cSt (11.4 g), a polyalphaolefin with a viscosity of 40 cSt (17.10 g), and a chemical dispersant (1.50 g) in a 100 mL beaker was heated on a hot plate with stirring until a homogenous solution was obtained. It typically takes about 10-20 min. Then, Carbolex single wall carbon nanotubes (4.46 g) were added to the mixture in a beaker and blended with a three-roll mill to optimum consistency. Total six nanogreases were prepared using one of following six chemical dispersants: OLOA 11002, AEROSOL® OT-S, C500, NaSul CA-HT3, Lz935, and FOA-5.

### Example X

### Characterization of Nanogreases

One important physical aspect of a grease is the stability of the grease structure as provided by the oil thickener, that is, carbon nanoparticles in the present invention. Two tests that measure this aspect of grease rheology were chosen to evaluate those nanogrease: dropping point (ASTM D2265) and oil separation (FTM 321.3). The ASTM. dropping point is the temperature at which a grease passes from a semi-solid to a liquid state under the conditions of the test. In this experiment, the dropping point was determined by heating the sample to the point being the temperature at which the first drop of material falls from the test cup. For the nanogrease with 5% by weight of SWNT in DURASYN® 166, it was not possible to determine its dropping point. The grease started to be carbonized at 316° C.

Oil separation test was run at 100° C. for 30 hrs. For the nanogrease with 5% by weight of SWNT in DURASYN® 166, no visible oil has separated from grease.

As shown in Table 3, both nanogreases have very high dropping point, indicating that these greases are very stable and do not melt.

TABLE 3
Characterization of Nanogreases

| | | Oil Separation |
|---|---|---|
| Test Description | Dropping Point | % (wt) |
| 3% D-SWNT-CNI in | 265 | 16.6 |
| DURASYN ® 166 | | |
| 5% D-SWNT-CNI in | did not drop | 0.67 |
| DURASYN ® 166 | | |

### Example XI

### Determination of the Thermal Conductivities of Carbon Nanotube-Containing Fluids

The thermal conductivities of the nanolubricants and nanogreases of the present invention were measured at room temperature using a hot disk thermal constant analyzer (Swedish Inc.). Sensor depth was set at 6 mm. Out power was set at 0.025 W. Means time was set at 16 s. Radius was set at 2.001 mm. TCR was set at 0.00471/K. Disk type of kapton was used. Tem. drift rec was on. As shown in Table 4, the thermal conductivity is increased as the amount of carbon nanoparticles increases.

TABLE 4
The thermal conductivity of nanolubricants and nanogreases

| Detail description | TC value |
|---|---|
| DURASYN ® 166 with 5 w % OLOA11002 | 0.153 |
| ROYCO ® 500 with 0.1 w % MWNT-HMSI and | 0.182 |
| 5 w % AEROSOL ® OT-MSO | |
| DURASYN ® 166 with 0.1 w % MWNT-HMSI | 0.186 |
| and 5 w % AEROSOL ® OT-MSO | |
| ROYCO ® 500 with 0.1 w % MWNT-MER and | 0.179 |
| 5 w % AEROSOL ® OT-MSO | |
| ROYCO ® 500 with 0.1 w % MWNT-HMSI and | 0.177 |
| 5 w % AEROSOL ® TR70% | |
| DURASYN ® 166 with 3 w % D-SWNT-CNI and | 0.227 |
| 5 w % OLOA11002 | |

### Example XII

### Determination of pH Values of Carbon Nanoparticle Suspensions

The pH values of carbon nanoparticle suspensions in DURASYN® 166 and ROYCO® 500 fluids were measured using UP-10 pH meter (Denver Instrument at Denver, Colo.). In this experiment, the concentration of carbon nanotubes was varied from 0.02 to 1% by weight. In addition, five different kinds of carbon nanotubes were used, including three SWNTs, that is, acid-treated, untreated, and purified F-SWNT, and two MWNTs, that is, helix and catalytic. For comparison, the pH values of two original fluids, DURASYN® 166 and ROYCO® 500, were also determined. As summarized Table 5, vast majority of the samples are neutral and have their pH values close to 7. For those samples which have their pH values off the neutral pH, it may sometimes be beneficial to neutralize the samples to bring their pH values to 7 to prevent potential corrosion caused by acidity or basicity.

TABLE 5
pH values of Carbon Nanotube Suspensions

| | pH |
|---|---|
| Detail Description | value |
| DURASYN ® 166 | 8.0 |
| ROYCO ® 500 | 8.0 |
| DURASYN ® 166 with 0.02 w % acid treated | 6.9 |
| D-SWNT-CNI and 5 w % OLOA11002 | |
| DURASYN ® 166 with 0.01 w % acid treated | 7.5 |
| D-SWNT-CNI and 5 w % OLOA11002 | |
| DURASYN ® 166 with 0.5 w % | 6.2 |
| untreated D-SWNT-CNI | |
| DURASYN ® 166 with 1 w % untreated | 8.2 |
| D-SWNT-CNI and 5 w % OLOA11002 | |
| DURASYN ® 166 with 0.5 w % untreated | 6.6 |
| D-SWNT-CNI and 45 w % DMF | |
| DURASYN ® 166 with 0.25 w % | 5.2 |
| F-SWNT-CNI and 5 w % DMF | |
| DURASYN ® 166 with 0.25% acid | 6.4 |
| treated D-SWNT-CNI and 45 w % DMF | |
| ROYCO ® 500 with 0.1 w % MWNT-HMSI | 7.0 |
| and 5 w % AEROSOL ® OT-MSO | |
| DURASYN ® 166 with 0.1 w % MWNT-HMSI | 7.2 |
| and 5 w % AEROSOL ® OT-MSO | |
| ROYCO ® 500 with 0.1 w % MWNT-MER and | 8.0 |
| 5 w % AEROSOL ® OT-MSO | |
| ROYCO ® 500 with 0.1 w % MWNT-HMSI and | 7.9 |
| 5 w % AEROSOL ® TR70% | |

In summary, several surfactants were used in the nanofluids of the present invention, including OLOA 11002, AEROSOL® OT-S, OT-MSO, and TR-75%, AE C500, NaSul CA-HT3, Lz935, and FOA-5. Among the surfactants, AEROSOL® OT-MSO and TR-75%, both of which are sulfosuccinate surfactants, are the most effective dispersants. The nanofluids with these two surfactants also have significantly enhanced stability.

The examples set forth above are provided to give those of ordinary skill in the art with a complete disclosure and description of how to make and use the preferred embodiments of the compositions and the methods, and are not intended to limit the scope of what the inventors regard as their invention. Modifications of the above-described modes for carrying out the invention that are obvious to persons of skill in the art are intended to be within the scope of the following claims. All publications, patents, and patent applications cited in this specification are incorporated herein by reference as if each such publication, patent or patent application were specifically and individually indicated to he incorporated herein by reference.

What is claimed is:

1. A method for producing a nanofluid with enhanced thermal properties comprising a step of dispersing carbon nanoparticles into a mixture comprising a thermal transfer fluid and at least one surfactant with intermittent ultrasonication.

2. The method of claim 1, wherein the nanoparticle is selected from the group consisting of diamond nanoparticles, graphite nanoparticles, fullerenes, carbon nanotubes, and combinations thereof.

3. The method of claim 1, wherein the nanoparticle is a carbon nanotube.

4. The method of claim 3, wherein the nanotube has an diameter of from about 0.2 to about 100 nm.

5. The method of claim 3, wherein the nanotube has an aspect ratio of no greater than 1,000,000.

6. The method of claim 3, wherein the nanotube has a thermal conductivity of no less than 10 W/m·K.

7. The method of claim 1, wherein the surfactant is an anionic surfactant.

8. The method of claim 7, wherein the anionic surfactant is a sulfonate surfactant.

9. The method of claim 7, wherein the anionic surfactant is a sulfosuccinate, a sulfosuccinamate, or a combination thereof.

10. The method of claim 9, wherein the sulfosuccinate is dioctyl sulfosuccinate, bistridecyl sulfosuccinate, or di(1,3-di-methylbutyl)sulfosuccinate.

11. The method of claim 1, wherein the thermal transfer fluid is selected from the group consisting of petroleum distillates, synthetic petroleum oils, greases, gels, oil-soluble polymer composition, vegetable oils, and combinations thereof.

12. The method of claim 1, wherein the organic oil is a synthetic petroleum oil.

13. The method of claim 12, wherein the synthetic petroleum oil is selected from the group consisting of polyalphaolefins, polyol esters, and combinations thereof.

14. The method of claim 13, wherein the polyol ester is pentaerythritol ester, trimethylolpropane ester, or neopentyl glycol ester.

15. A method for producing a nanofluid with enhanced thermal properties comprising the steps of:
dispersing carbon nanoparticles in a volatile solvent with a first physical mixing method to form an intermediate dispersion;
adding a mixture comprising a thermal transfer fluid and at least one surfactant to the intermediate dispersion;
mixing thoroughly with a second physical mixing method; and
removing the volatile solvent.

16. The method of claim 15, wherein the nanoparticle is selected from the group consisting of diamond nanoparticles, graphite nanoparticles, fullerenes, carbon nanotubes, and combinations thereof.

17. The method of claim 15, wherein the thermal transfer fluid is selected from the group consisting of petroleum distillates, synthetic petroleum oils, greases, gels, oil-soluble polymer composition, vegetable oils, and combinations thereof.

18. The method of claim 15, wherein the thermal transfer fluid is a synthetic petroleum oil.

19. The method of claim 18, wherein the synthetic petroleum oil is selected from the group consisting of polyalphaolefins, polyol esters, and combinations thereof.

20. The method of claim 19, wherein the polyol ester is pentaerythritol ester, trimethylolpropane ester, or neopentyl glycol ester.

21. The method of claim 15, wherein the volatile solvent has a boiling point of below 150° C.

22. The method of claim 15, wherein the volatile solvent is an organic solvent.

23. The method of claim 22, wherein the organic solvent is selected from the group consisting of halogenated solvents, ethers, carboxylic esters, carbonyl solvents, nitriles, and amides, and combinations thereof.

24. A method for producing a nanofluid with enhanced thermal properties comprising the steps of:
preparing a mixture comprising a thermal transfer fluid and at least one surfactant;
heating the mixture to a predetermined temperature; and
dispersing carbon nanoparticles into the heated mixture with a physical agitation;

25. The method of claim 24, wherein the nanoparticle is selected from the group consisting of diamond nanoparticles, graphite nanoparticles, fullerenes, carbon nanotubes, and combinations thereof.

26. The method of claim 24, wherein the nanoparticle is a carbon nanotube.

27. The method of claim 24, wherein the surfactant is an anionic surfactant, a nonionic surfactant, or a combination thereof.

28. A nanolubricant with enhanced thermal conductivities comprising a thermal transfer fluid, carbon nanoparticles, and at least one surfactant.

29. The nanolubricant of claim 28, wherein the thermal transfer fluid is selected from the group consisting of petroleum distillates, synthetic petroleum oils, greases, gels, oil-soluble polymer composition, vegetable oils, and combinations thereof.

30. The nanolubricant of claim 28, wherein the thermal transfer fluid is a synthetic petroleum oil.

31. The nanolubricant of claim 30, wherein the synthetic petroleum oil is selected from the group consisting of polyalphaolefins, polyol esters, and combinations thereof.

32. The nanolubricant of claim 31, wherein the polyol ester is pentaerythritol ester, trimethylolpropane ester, and neopentyl glycol ester.

33. The nanolubricant of claim 28, wherein the amount by weight of the carbon nanoparticles is no greater than about 30%.

34. The nanolubricant of claim 28, wherein the nanoparticle is selected from the group consisting of diamond nanoparticles, graphite nanoparticles, fullerenes, carbon nanotubes, and combinations thereof.

35. The nanolubricant of claim 28, wherein the nanoparticle is a carbon nanotube.

36. The nanolubricant of claim 35, wherein the nanotube has a diameter of from about 0.2 to about 100 nm.

37. The nanolubricant of claim 35, wherein the nanotube has an aspect ratio of no greater than 1,000,000.

38. The nanolubricant of claim 35, wherein the nanotube has a thermal conductivity of no less than 10 W/m K.

39. The nanolubricant of claim 28, wherein the surfactant is an anionic surfactant.

40. The nanolubricant of claim 39, wherein the anionic surfactant is a sulfonate surfactant.

41. The nanolubricant of claim 40, wherein the anionic surfactant is a sulfosuccinate, a sulfosuccinamate, or a combination thereof.

42. The nanolubricant of claim 41, wherein the sulfosuccinate is selected from the group consisting of dioctyl sulfosuccinate, bistridecyl sulfosuccinate, di(1,3-di-methylbutyl)sulfosuccinate, and combinations thereof.

43. The nanolubricant of claim 28, wherein the amount of the surfactant is about from 0.1 to about 30% by weight.

44. A nanogrease with enhanced thermal conductivities comprising a thermal transfer fluid, carbon nanoparticles, and at least one surfactant.

45. The nanogrease of claim 44, wherein the thermal transfer fluid is selected from the group consisting of petroleum distillates, synthetic petroleum oils, greases, gels, oil-soluble polymer composition, vegetable oils, and combinations thereof.

46. The nanogrease of claim 44, wherein the thermal transfer fluid has a viscosity of from about 2 to about 800 centistokes.

47. The nanogrease of claim 44, wherein the thermal transfer fluid is a synthetic petroleum oil.

48. The nanogrease of claim 47, wherein the synthetic petroleum oil is selected from the group consisting of polyalphaolefins, polyol esters, and combinations thereof.

49. The nanogrease of claim 48, wherein the polyol ester is pentaerythritol ester, trimethylolpropane ester, or neopentyl glycol ester.

50. The nanogrease of claim 44, wherein the amount by weight of the carbon nanoparticles is no greater than about 30%.

51. The nanogrease of claim 44, wherein the nanoparticle is selected from the group consisting of diamond nanoparticles, graphite nanoparticles, fullerenes, carbon nanotubes, and combinations thereof.

52. The nanogrease of claim 44, wherein the nanoparticle is a carbon nanotube.

53. The nanogrease of claim 52, wherein the nanotube has a diameter of from about 0.2 to about 100 nm.

54. The nanogrease of claim 52, wherein the nanotube has an aspect ratio of on greater than 1,000,000.

55. The nanogrease of claim 52, wherein the nanotube has a thermal conductivity of no less than 10 W/m K.

56. The nanogrease of claim 44, wherein the surfactant is an anionic surfactant or a mixture of an anionic and nonionic surfactant.

57. The nanogrease of claim 56, wherein the anionic surfactant is a sulfonate surfactant.

58. The nanogrease of claim 56, wherein the anionic surfactant is a sulfosuccinate, a sulfosuccinamate, or a combination thereof.

59. The nanogrease of claim 58, wherein the sulfosuccinate is dioctyl sulfosuccinate, bistridecyl sulfosuccinate, or di(1,3-di-methylbutyl)sulfosuccinate.

60. The nanogrease of claim 44, wherein the amount of surfactant is about from 0.1 to about 30% by weight.
